(19) United States
(12) Patent Application Publication
(10) Pub. No.: US 2020/0104441 A1
(43) Pub. Date: Apr. 2, 2020

(54) THERMAL ENERGY STORAGE SIMULATOR SYSTEM

(71) Applicant: Michael ROPPELT, Edmonton (CA)

(72) Inventor: Michael ROPPELT, Edmonton (CA)

(21) Appl. No.: 16/149,568

(22) Filed: Oct. 2, 2018

(51) Int. Cl. G06F 17/50

(52) U.S. Cl. CPC G06F 17/5018; G06F 2217/16

(57) ABSTRACT

A thermal energy storage simulator system has a design tool, a simulation analyzer and an output tool. The design tool has a user input that allows a user to enter project characteristics, constant parameters and a recommendation output. The recommendation output creates a set of recommended parameters based upon the project characteristics provided by the user. The design tool creates a saved set of system parameters. The simulation analyzer is in communication with the design tool. The saved set of system parameters are transferred to the simulation analyzer. Simulation analyzer has an input for entering variables and the simulation analyzer creates a saved simulation. The output tool is in communication with the design tool and the simulation analyzer such that the set of system parameters and the saved simulation are transferred to the output tool. The output tool has an output for expressing the data to the user. The output tool has a database for generating and recording the simulation results.

System for the detailed simulation of seasonal thermal energy storage systems.

### FIELD OF THE DISCLOSURE

The present application relates generally to a modeling and simulation of real world systems, more particularly it relates to the modeling and simulation of injection, storage, and extraction of thermal energy in a bore field.

### BACKGROUND

This section provides background information to facilitate a better understanding of the various aspects of the invention. It should be understood that the statements in this section of this document are to be read in this light, and not as admissions of prior art.

A terra-thermal energy exchange and storage (TEES) system is a specialized variation of seasonal thermal energy storage (STES) systems that comprises a soil formation divided into multiple ring-shaped zones. Each zone contains a plurality of boreholes. All zones are positioned concentrically so that each additional zone is outwards from and encircling a prior zone. Each borehole contains several U-tubes that are constructed of two pipes and a u-bend connecting the two pipes at the bottom of the hole, such that one pipe carries fluid to the bottom of the hole, and the matched pipe carries fluid back to the top of the hole. The TEES system can have multiple operating temperature zones that can function independently and simultaneously based on the locations, thermal drivers and demands. Temperature differential from center to outer zone could be as high as 60° C.-70° C.

Finite element analysis (FEA) is a numerical method for solving problems in engineering and mathematical physics. FEA works by breaking down a real object into a large number (thousands to hundreds of thousands) of small elements, such as cubes or pyramids or tetrahedrons, using mathematical equations to predict effects over each element, and then adding up the individual effects to predict a global effect. FEA is used to assist in solving the heat transfer problems in the 3D ground volume.

Within simulation environments, there are two types of numbers that are used within the equations that can be defined: parameters and inputs. Parameters are numbers that must remain constant throughout the simulation, such as thermal resistivity, distances between boreholes, and other known constants. Inputs are numbers that can remain constant but can also be variable and change as the simulation progresses, such as fluid flow rates and fluid temperatures.

### BRIEF SUMMARY

Provided is a thermal energy storage simulator system that has a design tool, a simulation analyzer and an output tool.

The design tool has a user input, constant parameters and a recommendation output. The user input allows a user to enter project characteristics. The recommendation output creates a set of recommended parameters based upon the project characteristics provided by the user. The design tool creates a saved set of system parameters based upon the recommended parameters and project characteristics provided by the user.

The simulation analyzer is provided in communication with the design tool such that the saved set of system parameters are transferred to the simulation analyzer. The simulation analyzer has an input for entering variables and creates a saved simulation based upon the saved set of system parameters and the variables entered as inputs.

The output tool is provided in communication with the design tool and the simulation analyzer such that the saved set of system parameters and the saved simulation are transferred to the output tool. The output tool has an output for expressing the saved set of system parameters and the saved simulation to the user. The output tool has a database for generating and recording the simulation results.

In one embodiment, the project data includes the formation thermal conductivity, the total simulation duration and the simulation timestep duration.

In one embodiment, the project data includes maximum field length, the maximum field width, the maximum field depth, number of boreholes, number of zones, the size of the zones, separation distance between boreholes, radius of boreholes, the number of pipes in the boreholes, and size of pipes in the boreholes.

In one embodiment, the project data relates to a single flow system. A single flow system is connected to one driver that directs flow through the pipes in the thermal storage system. This allows for one simultaneous mode of operation, either injection or extraction, and the origin and destination for the flow in either mode is the same.

In one embodiment, the project data relates to a dual-flow system. A dual-flow system is connected to two separate drivers that direct flows to separate parallel pipes in the thermal storage system. This allows for two simultaneous modes of operation, both injection and extraction at the same time, and the origin and destination for the two flows can be independent.

In one embodiment, the project data includes inlet temperature and inlet flow rate as constant inputs entered manually.

In one embodiment, the project data includes inlet temperature and inlet flow rate as variable inputs, either entered manually as a self-contained time-dependent equation or entered by another computer resource from some other time-dependent source.

In one embodiment, the input variables may vary between different portions of the modelled thermal energy storage system. This allows different variables to be utilized for different zones, an injection system and an extraction system as needed.

In one embodiment, the at least one recommendation output is adjustable by the user within limits imposed by site and project characteristics.

In one embodiment, the user input accepts characters of heating demand, cooling demand, heat production capacity and ground thermal properties to provide a more realistic simulation. The more information provided by the user, the more detailed and accurate the simulation is likely to be.

In one embodiment, the design tool uses a finite element analysis (FEA) method specifically with an element shaped as a quadratic tetrahedron, to create part of the recommended parameters.

In one embodiment, the input of the simulation analyzer accepts a dynamic input for the input variables from a second simulation source such as a third-party simulator.

In one embodiment, the input of the simulation analyzer accepts multiple inputs of heat information. This allows different heat zones to be created and simulated.

In one embodiment, the output of the output tool expresses the saved simulation data in a chart or graphical form. The user may choose how they wish to see the saved simulation data. For example, the temperature and heat flow results may be provided in chart or graphical form.

In one embodiment, the output tool updates the design tool as the simulation is being executed. This allows the output tool to provide feedback to the design tool as the simulation progresses and alter the recommended parameters based upon the simulation data.

In one embodiment, the output of the output tool updates the simulation analyzer as the simulation is executed. This allows the output tool to provide feedback to the simulation analyzer as the simulation is executed.

The thermal energy storage simulator system is designed to simulate a terra-thermal energy exchange and storage (TEES) system, however, it has the capacity to also support the simulation of conventional geothermal and borehole thermal energy storage designs and functions.

### BRIEF DESCRIPTION OF THE FIGURES

FIG. 1 is a schematic view of a TEES system, showing a variety of the bore field characteristics including multiple ring-shaped sections arranged concentrically or in a cluster configuration.

FIG. 2 is a schematic view of a map of ground loop interactions used for resistance equivalence calculations of the TEES system borehole using 2 U-tubes.

FIG. 3 is a schematic view of a map of ground loop interactions used for resistance equivalence calculations of the TEES system borehole using 4 U-tubes.

FIG. 4 is a graphical representation of the Geometry and Faces definitions of a cross-section of the bore field as it is constructed for the 3D Finite Element Analysis method.

FIG. 5 is a schematic view of a tetrahedral node mesh constructed for the simulation model used in the 3D Finite Element Analysis method.

FIG. 6 is a top plan view of six different pipe connection arrangements corresponding to the simulation results in FIG. 7 and FIG. 8.

FIG. 7 is a graph of the simulation results of the temperature of the fluid in the hot injection loops with different pipe arrangements of four U-tubes.

FIG. 8 is a graph of the simulation results of the temperature of the fluid in the cold extraction loops with different pipe arrangements of four U-tubes.

FIG. 9 is a schematic view of the thermal energy storage simulator system.

### DETAILED DESCRIPTION OF THE PREFERRED EMBODIMENTS

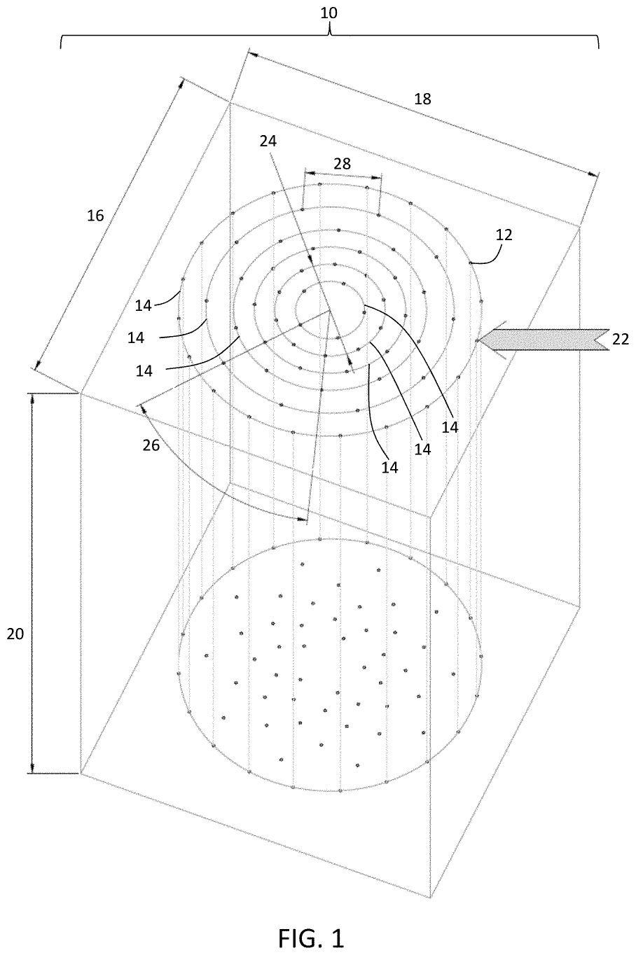

A thermal energy storage simulator system, generally identified by reference number 10, will now be described with reference to FIG. 1 through FIG. 9.

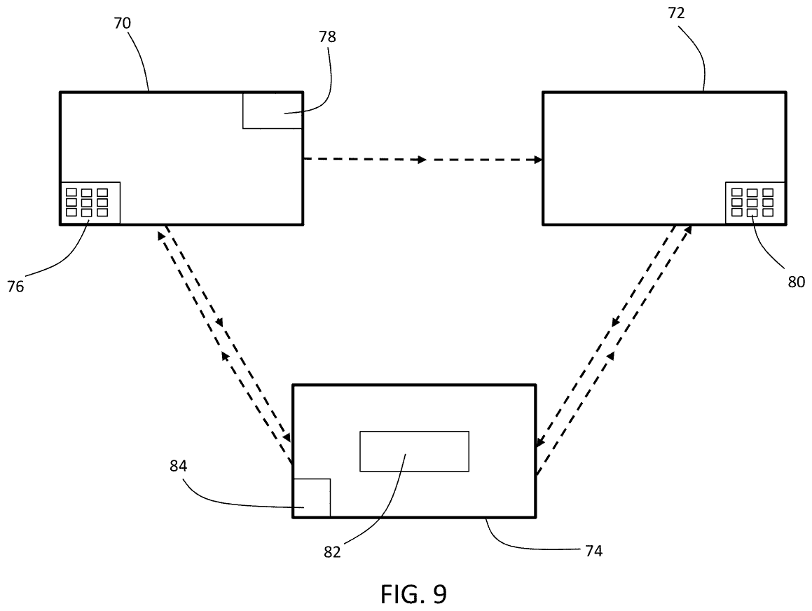

Referring to FIG. 9, system 10 consists of 3 major components: a design tool 70, a simulation analyzer 72 and an output tool 74.

Design tool 70 is used to determine the design characteristics for thermal storage bore fields 10, shown in FIG. 1. Referring to FIG. 1, an example of a thermal storage bore field 10 with vertical boreholes 12 is shown. While it was built specifically to design bore fields 10 for terra-thermal energy exchange and storage (TEES) systems with ring-shaped zones 14, it is flexible enough to enable design of geothermal and borehole thermal energy storage (BTES) systems, referred to collectively as ground heat exchangers.

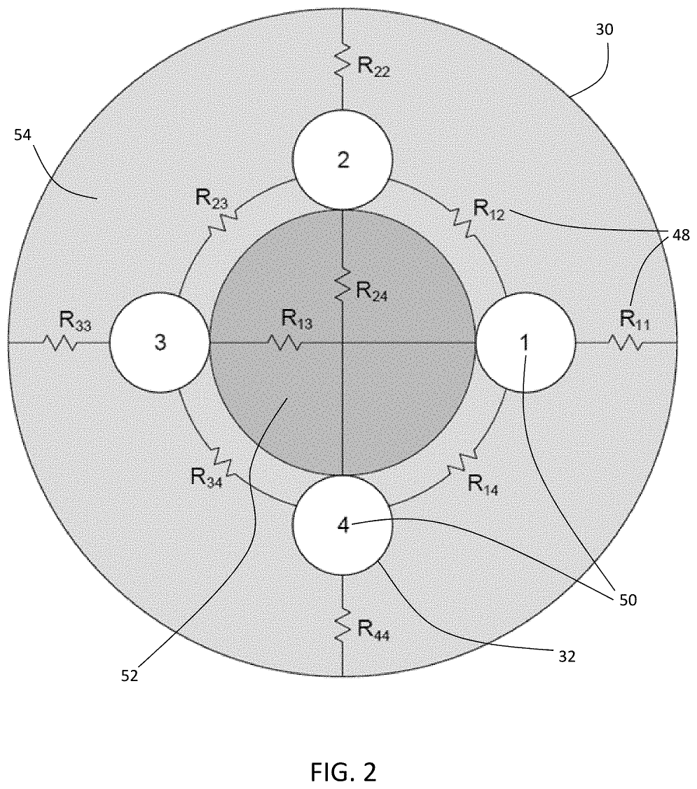

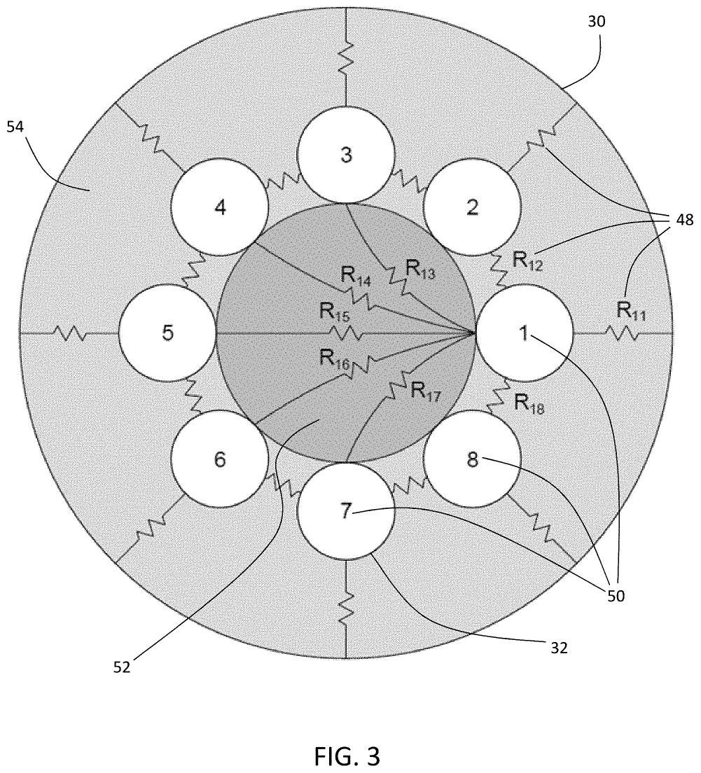

Referring to FIG. 9, design tool 70 has a user input 76 that allows a user to enter project characteristics into design tool 70. Referring to FIG. 1, project characteristics include length 16, width 18, and depth 20 of boreholes based on test hole drilling log and thermal conductivity results on the site, the predicted thermal inputs 22, as well as the heating and cooling demands on the system. The user should also specify if the system to be simulated is configured to be single-flow or dual-flow system for simultaneous energy injection and extraction. Design tool 70, shown in FIG. 9, uses the project characteristics to recommend a set of recommended parameters that are predicted to accommodate the thermal inputs. On a large scale, these recommended parameters include the length of thermal exchange pipe, quantity of boreholes 12 required for depth 20 of bore field 10, the number of ring-shaped zones 14, the diameter 24 of each ring-shaped zone, and the angular separation 26 and corresponding linear separation 28 of boreholes 12 in each zone. Referring to FIG. 2 and FIG. 3, on a small scale, these additional parameters include features of the borehole 12 contents such as the radius to the borehole wall 30 and the number and size of pipes 32 in borehole 12. There are interactions between the borehole and each of the pipes. In FIG. 3, only the interactions between pipe 1 and each of the other pipes (2-8) are labeled, and only the interactions between pipe 1 and pipes 3-7 across the center region are shown. Identical interactions do exist for each of the pipes to the pipes across the center region. Referring to FIG. 9, design tool 70 has constant parameters that are used when creating recommended parameters, for example characteristic load profiles for offices, residences, or retail spaces.

Referring to FIG. 9, a recommendation output 78 is provided to allow the user access to the recommended parameters within design tool 70. Once the recommended parameters have been made, recommendation output 78 of design tool 70 allows the user to adjust the recommended parameters within the constraints imposed on design tool 70 by the user-defined project characteristics and constant parameters. Some parameters, such as borehole depth 20, are partially dependent upon other factors and can only be adjusted within a limited range. Some parameters, such as number and size of pipes 32 are limited to a selection of pre-specified options that correspond to the industry-available options. The simulation time parameters should be entering by user using user input 76 to indicate the amount of time to be simulated. Once the user is satisfied with the parameters, design tool 70 creates a saved set of system parameters.

The saved set of system parameters are transferred to simulation analyzer 72. Simulation analyzer 72 has an input 80 for entering variables into simulation analyzer 72. Variables include the inlet temperature and the flow rate of the fluid moving through the pipes in the system. Simulation analyzer 72 can support multiple matched pairs of inlet temperatures and flow rates. These variables can be entered manually through input 80 as constants with simulation analyzer 72 running the simulation in isolation. However, these variables can also be dynamically changing numbers supplied by a second simulation source to input 80 through the use of simulation software that varies the variables in response to outside factors such as weather data.

Simulation analyzer 72 models the performance of a thermal storage system over time using the saved set of system parameters and variables entered by the user into input 80 or a simulation program that simulates other parts of a thermal energy system, such as HVAC heat pumps, boilers, or solar water heaters. When connected to a dynamic/transient simulation program, simulation analyzer 72 can dynamically model a thermal exchange and storage system.

Once the saved set of parameters have been transferred to simulation analyzer 72 and the variables are entering into input 80, the user can activate simulation analyzer 72 which will incorporate unit input 76 (references 16-18) and recommendation output 78 to iteratively simulate the thermal changes on the soil formation over the defined simulation time.

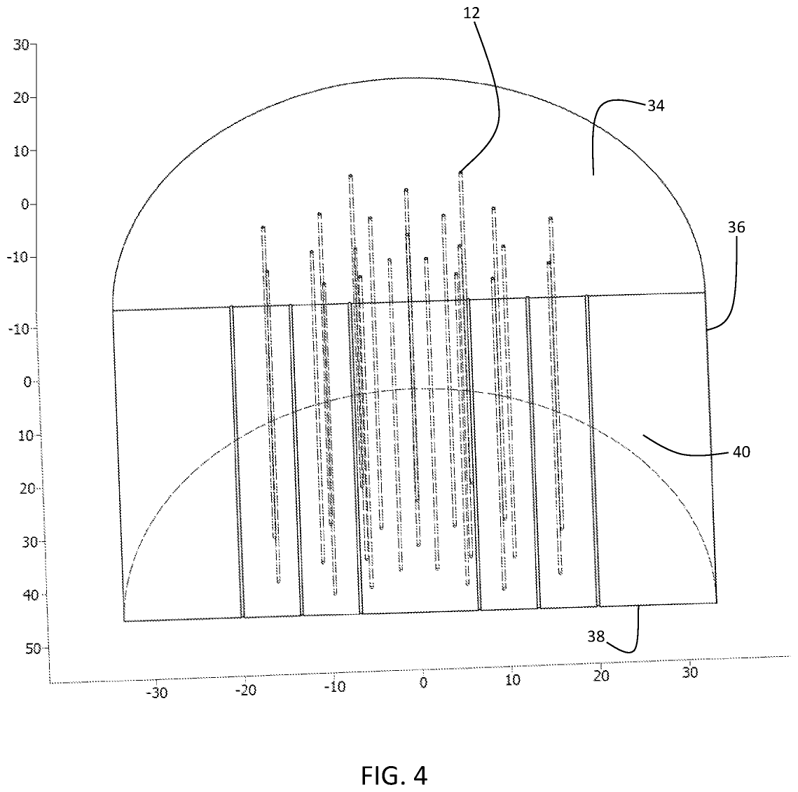

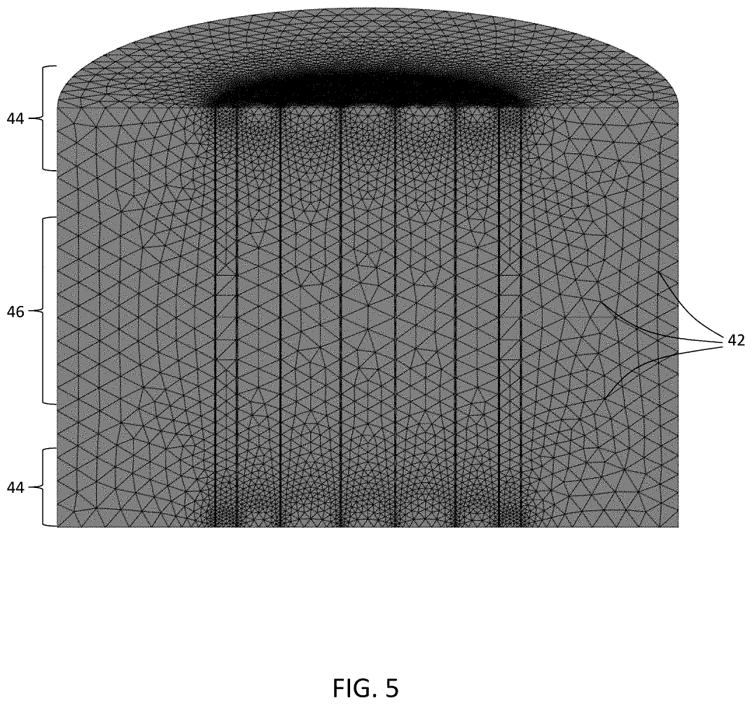

Referring to FIG. 4 and FIG. 5, a quadratic tetrahedron 3D finite element method is used to address the variation of thermal properties along the y-axis (depth) of the model so that a more visualized and accurate 3D ground temperature profile can be provided. Design tool 70 uses the quadratic tetrahedron 3D finite element analysis to create the recommended parameters based upon the project characteristics input into design tool 70 by the user.

Simulation analyzer 72 defines the bore field geometry, in the form of boundaries with defined shapes and dimensions and conditions associated with those boundaries. The embodiment shown in FIG. 4 is a graphical representation of the geometry of bore field 10 and boreholes determined using design tool 70. The top surface 34, side surface 36, and bottom surface 38 are all defined, as are each borehole 12 in the field. The boundary definitions shown on the geometry diagram are defined within the mathematical simulation as faces 40.

The embodiment shown in FIG. 5 depicts the tetrahedral mesh that is created from the bore field geometry. The lines of the mesh represent the finite element interactions over which heat is transferred. The points where multiple lines intersect are defined within the simulation as nodes 42. Note that the mesh has variations in the density of nodes 42 due to the complexity of potential interactions. In the top center and bottom center of the field are high-density node regions 44, where there are many important interactions between boreholes 12, top surface 30 and bottom surface 34. The remainder of the field is a low-density node region 46, where the complexity of the calculation set can be reduced to improve performance.

The simulation of TEES ground heat exchangers requires additional dynamic flexibility that is possible through use of simulator system 10. As shown in the embodiment in FIG. 1, TEES ground heat exchangers utilize sectional storage regions within the soil formations, specifically ring-shaped zones 14, where fluid flow can be directed to inject or extract heat from one zone 14 independent of other zones 14. Simulator system 10 features an advanced ground heat exchanger model that is embedded with control logic equations to alter the simulation parameters to simulate directing thermal input 22 to any specified zones 14 either in series or in parallel, as well as boreholes 12 within zones 14 either in series or in parallel. These control logic equations are pre-defined to optimize the simulated injection and extraction of thermal input 22 in bore field 10.

To mathematically characterize the borehole in the simulation, the calculation of an equivalent thermal resistance of pipes 32 (organized as U-tubes) in a single borehole is conducted. The simulation of TEES ground heat exchangers can calculate two U-tubes (i.e. four pipes), as in the embodiment shown in FIG. 2, up to the equivalent thermal resistance for four U-tubes (i.e. eight pipes), as in the embodiment shown in FIG. 3, which are dual-flow systems allowing simultaneous injection and extraction of heat. The calculation combines thermal interactions 48 between individual pipes 32 and borehole wall 30. In FIG. 2 and FIG. 3, pipes 32 are assigned designations 50 and interactions 48, shown crossing central thermal transfer region 52 and outer thermal transfer region 54, are labeled with designations 50 corresponding to the relevant pipes 32.

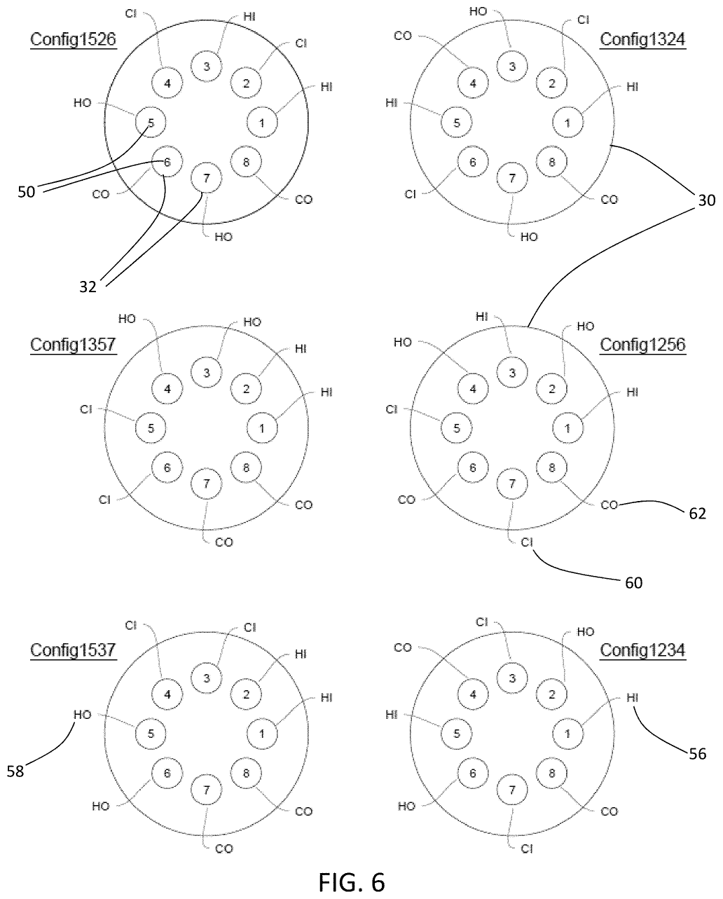

As shown in the embodiment depicted in FIG. 3, the presence of four U-tubes results in eight pipes 32 within a single borehole 12. The possible variations of connecting these pipes 32 to a dual-flow system can result in some variability in the simulated temperature of bore field 10. To account for this variability in any given system, the simulation can calculate the amount of error in the simulation temperature results through varying the connection positions. Six different variations in connections are illustrated in FIG. 6, and are labeled to show where the injection (hot) inlets (HI) 56 and outlets (HO) 58 can be positioned along with the corresponding extraction (cold) inlets (CI) 60 and outlets (CO) 62. Each connection variation is assigned a configuration label. The four digits in the label indicate the location of a hot inlet (1^{st} digit) and its matching hot outlet (2^{nd} digit) as well as the location of a cold inlet (3^{rd} digit) and its matching cold outlet (4^{th} digit). The difference in results between these variations is the amount of error possible in the simulated temperature of bore field 10.

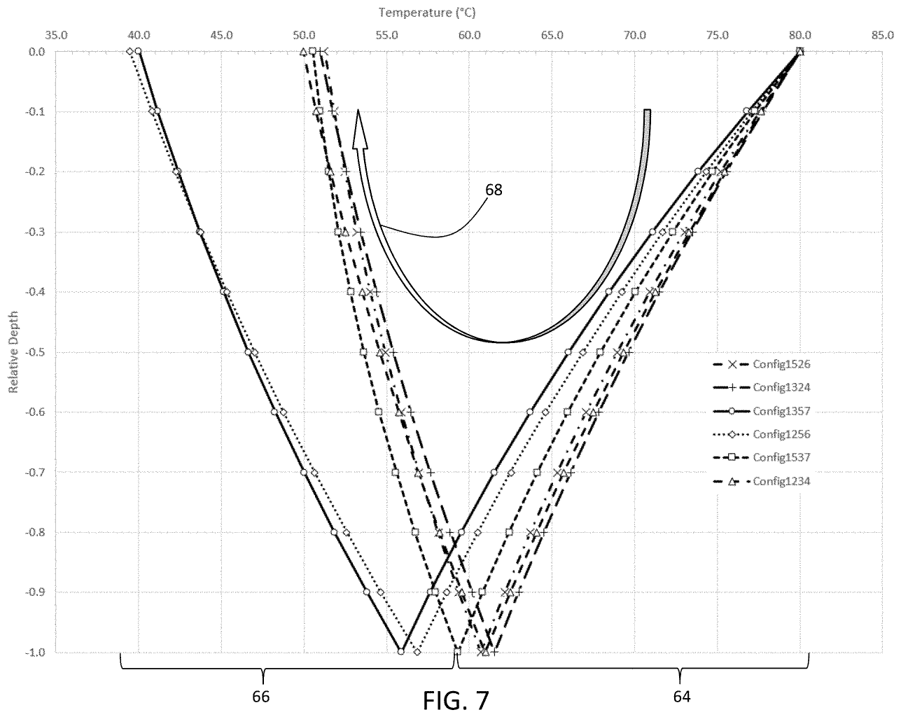

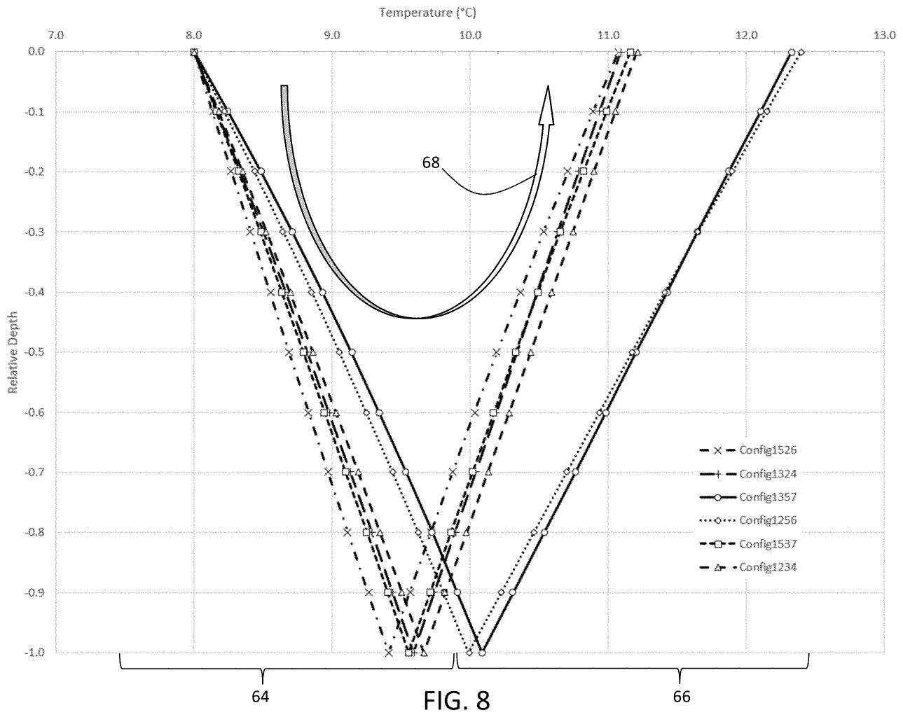

The graphs shown in FIG. 7 and FIG. 8 demonstrate the variability in simulated bore field 10 temperature possible from the connection variations. The configuration labels in the legend match those of the diagrams in FIG. 6. Each graph shows the data from an entire U-tube, indicating the data for the inlet/downhole side of the loop (inlet data 64), the data for the outlet/up-hole side of the loop (outlet data 66), and indicating the direction of flow 68. Simulation analyzer 72 creates a saved simulation with all the data obtained through the simulation.

Referring to FIG. 9, output tool 74 is used to display the results of design tool 70 and simulation analyzer 72. Output tool 74 is provided in communication with design tool 70 and simulation analyzer 72 such that the saved set of system parameters and the saved simulation are transferred to output tool 74. Output tool 74 has an output 82 for expressing the saved set of system parameters and the saved simulation to the user. It will be understood by a person skilled in the art that output 82 may be a screen, printer or connection to a computer, screen, mobile device or any other device known in the art capable of expressing the saved set of system parameters and saved simulation to the user. Output tool 82 has a database 84 for generating and recording the simulation results for later recall, display and analysis. Output tool 74 can operate concurrently with design tool 70 and simulation analyzer 72 to display results immediately as they are generated.

Basic expectations for the performance of a TEES system matched to the user-supplied heating and cooling loads can be automatically calculated and expressed in chart form without the need for a simulation to be run. The expression of these basic performance expectations is done by output tool 74 on an ongoing basis after the recommended parameters are calculated by design tool 70. Whenever the user modifies the project characteristics or system parameters, the basic performance expectations are updated.

Information from simulation analyzer 72, for example the outlet temperature of the fluid flow from the TEES system, can be expressed by output tool 74 on an ongoing basis during the execution of the simulation analyzer process. These can be expressed in a trending chart form by output tool 74. The ground-related results, particularly the ground temperature of bore field cross-sections can be expressed by output tool 74 as graphical snapshots of the conditions at a timestamp. The graphic is dynamic, updating as the simulation progresses. Once the simulation has been completed, various stages of the simulation can be compared to each other through accessing database 84.

This embodiment of simulation system 10 was invented specifically for the simulation of terra-thermal energy and exchange storage systems. However, the close similarity that TEES systems have to borehole thermal energy storage (BTES) systems and conventional geothermal systems allows simulation system 10 to accurately model the behaviour of those systems as well.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A thermal energy storage simulator system, comprising:
a design tool having a user input, constant parameters and a recommendation output, the user input allowing a user to enter project characteristics, the recommendation output creating a set of recommended parameters based upon the project characteristics provided by the user, the design tool creating a saved set of system parameters;
a simulation analyzer in communication with the design tool such that the saved set of system parameters is transferred to the simulation analyzer, the simulation analyzer having an input for entering variables, the simulation analyzer creating a saved simulation;
an output tool in communication with the design tool and the simulation analyzer such that the saved set of system parameters and the saved simulation are transferred to the output tool, the output tool having an output for expressing the saved set of system parameters and the saved simulation to the user, the output tool having a database for generating and recording the simulation results.

2. The thermal energy storage simulator system of claim 1 wherein the project characteristics include borehole dimensions and time parameters.

3. The thermal energy storage simulator system of claim 1 wherein the set of recommended parameters includes bore field dimensions, number of boreholes, number of zones, separation distance between boreholes, radius of boreholes and size of pipes in borehole.

4. The thermal energy storage simulator system of claim 2 wherein the borehole dimensions are adjustable to simulate a variable number of u-tubes within each borehole.

5. The thermal energy storage simulator system of claim 1 wherein the set of recommended parameters of the project characteristics relate to a single flow system.

6. The thermal energy storage simulator system of claim 1 wherein the set of recommended parameters of the project characteristics relate to a dual flow injection and extraction systems.

7. The thermal energy storage simulator system of claim 6 wherein the input of the simulation analyzer accepts multiple inputs of heat information related to the injection and extraction systems.

8. The thermal energy storage simulator system of claim 1 wherein the input variables include inlet temperature and flow rate of the system.

9. The thermal energy storage simulator system of claim 1 wherein the input variables may vary between different portions of the modelled thermal energy storage system.

10. The thermal energy storage simulator system of claim 1 wherein at least one of the recommended parameters being user adjustable within limits imposed by the project characteristics.

11. The thermal energy storage simulator system of claim 1 wherein the user input further accepting the project characteristics of heating demand, cooling demand, heat production capacity and ground thermal properties.

12. The thermal energy storage simulator system of claim 1 wherein the design tool uses a quadratic tetrahedron 3D finite element analysis to create the recommended parameters.

13. The thermal energy storage simulator system of claim 1 wherein the input of the simulation analyzer accepting a dynamic input for the input variables from a second simulation source.

14. The thermal energy storage simulator system of claim 1 wherein the input of the simulation analyzer accepting multiple inputs of heat information.

15. The thermal energy storage simulator system of claim 1 wherein the output of the output tool expresses the saved simulation data in a chart form.

16. The thermal energy storage simulator system of claim 1 wherein the output tool updates the design tool as the simulation is being executed.

17. The thermal energy storage simulator system of claim 1 wherein the output of the output tool expresses temperature and heat flow results in a chart form.

18. The thermal energy storage simulator system of claim 1 wherein the output of the output tool expresses temperature and heat flow results in a graphical form.

19. The thermal energy storage simulator system of claim 1 wherein the output tool updates the simulation analyzer as the simulation is executed.
